(19) United States
(12) Patent Application Publication
(10) Pub. No.: US 2006/0141852 A1
(43) Pub. Date: Jun. 29, 2006

(54) Connector

(75) Inventors: Koki Sato, Shinagawa (JP); Atsushi Sakurai, Shinagawa (JP); Manabu Shimizu, Shinagawa (JP); Hideo Miyazawa, Shinagawa (JP)

Correspondence Address: STAAS & HALSEY LLP, SUITE 700, 1201 NEW YORK AVENUE, N.W., WASHINGTON, DC, 20005, US

(73) Assignee: FUJITSU COMPONENT LIMITED, Tokyo (JP)

(21) Appl. No.: 11/184,867

(22) Filed: Jul. 20, 2005

(30) Foreign Application Priority Data
Dec. 28, 2004 (JP) 2004-380580

(51) Int. Cl. H01R 12/24

(52) U.S. Cl. 439/492

(57) ABSTRACT

A connector is disclosed. A plate contact member is fixed to a housing of the connector. The contact member includes an FFC connection contact section. The FFC connection contact section is formed in a U-shape, and includes a base section on which a triangular projection is formed. An FFC is held between the base section and a slider fitted in the housing. The projection pierces a covering of the FFC to come into contact with a wire of the FFC. Thus, the FFC is electrically and mechanically connected to the connector.

### BACKGROUND OF THE INVENTION

1. Field of the Invention

The present invention relates to a connector, and particularly relates to a connector for a flat ribbon cable connection to which an unterminated end of a flat ribbon cable, such as a flat flexible cable and a printed-wiring cable, having a conductive line covered with a covering is connected.

2. Description of the Related Art

Referring to FIG. 1, a flat flexible cable (FFC) 10 includes multiple copper wires 11, each serving as a conductive line and having a rectangular cross-sectional shape, arranged at predetermined intervals P. The FFC 10 is entirely laminated and covered with a polyester sheet, and is formed into a flat ribbon shape. A lamination polyester covering is denoted by the reference number 12. Both faces 13 and 14 are flat. A thickness of the polyester covering 12 is t.

This type of FFC 10 has become widely used in recent years because of the intervals p, which can be made as narrow as, for example, 0.5 mm, and low costs.

In an example of a connector with such an FFC connected thereto known in the art, a covering on one side of an end of an FFC is removed to expose wires therein, and the exposed wires are put into contact with contact members of the connector.

International Application No. PCT/US02/11143 (Published Japanese translation No. 2004-528692) discloses another example of a connector with such an FFC connected thereto. In this example, an unterminated FFC is placed on the upper side of U-shaped contact members. Then, the FFC is pushed into the contact members by an actuator so that the FFC forms a U-shape along the inner surface of the contact members. While the FFC is pushed into the contact members, a covering is cut to partially expose wires. Thus, a part of each of the contact members comes into contact with the corresponding exposed wire to establish an electrical connection.

Unfortunately, the first example is not cost-effective because it requires cable termination.

On the other hand, the second example does not have such a cost disadvantage because it requires neither cable termination nor soldering. However, in the process of connecting the contact members to the wires, the covering is tore, and the thus exposed wires are dragged on the contact members. This may damage the wires, resulting in lowering of reliability of the electrical connection between the contact members and the wires.

In the case of printed wiring cables, it is troublesome to solder contact members to terminal sections arranged at an end of a cable. If lead-free tin solder is used, short circuits might develop due to occurrence of whiskers.

### SUMMARY OF THE INVENTION

A general object of the present invention is to provide a connector device for flat ribbon cable connection to solve at least one problem described above.

According to an aspect of the present invention, there is provided a connector to which an end of a flat ribbon cable including a conductive line covered with a covering is to be connected, comprising: a housing; a contact member secured to the housing, including a flat flexible cable connection contact section that is formed in a U-shape for receiving the end of the flat flexible cable therein and includes a projection on at least one of opposing inner edges of the U-shaped flat flexible cable connection contact section; and a slider configured to elastically deform the flat ribbon connection contact section; wherein the flat flexible cable connection contact section and the slider are configured such that when the slider is fitted with respect to the flat flexible connection contact section an elastic force is generated in the flat flexible connection contact section, and the slider presses the flat flexible cable against said at least one of the opposing inner edges of the flat flexible connection contact section such that the projection pierces the covering of the flat flexible cable to come into contact with and press the conductive line.

According to the present invention, an end of a flat ribbon cable can be connected without soldering while preventing a wire from being dragged on and damaged by a projection.

### BRIEF DESCRIPTION OF THE DRAWINGS

FIG. 1 is a perspective view illustrating a flexible flat cable (FFC);

FIG. 2 is a perspective view illustrating a connector device according to a first embodiment of the present invention;

FIG. 3 is a cross-sectional view illustrating the connector device of FIG. 2;

FIG. 4 is a perspective view illustrating a plug connector;

FIG. 5 is an exploded perspective view illustrating the plug connector;

FIGS. 6A and 6B are cross-sectional views each illustrating the plug connector;

FIG. 7 is a cross-sectional view of a jack connector;

FIG. 8 is an exploded perspective view illustrating the jack connector;

FIG. 9 is an exploded perspective cross-sectional view of the jack connector;

FIG. 10 is an exploded perspective cross-sectional view of the jack connector with contact members mounted therein;

FIGS. 11A and 11B are diagrams illustrating operations for connecting the FFC to the jack connector;

FIGS. 12A and 12B are diagrams illustrating a relationship between projections and the FFC connected to the jack connector in detail;

FIG. 13 is a perspective view illustrating a connector device according to a second embodiment of the present invention;

FIG. 14 is a cross-sectional view of a jack connector;

FIG. 15 is an exploded perspective view of the jack connector;

FIG. 16 is an exploded perspective cross-sectional view of the jack connector;

FIG. 17 is a diagram illustrating operations for connecting the FFC to the jack connector;

FIG. 18 is a perspective view illustrating a connector device according to a third embodiment of the present invention;

FIG. 19 is a perspective view illustrating a plug connector;

FIGS. 20A and 20B are cross-sectional views each illustrating the plug connector; and

FIG. 21 is a perspective view illustrating a connector device according to a fourth embodiment of the present invention.

### DETAILED DESCRIPTION OF THE PREFERRED EMBODIMENT

The following description provides exemplary embodiments of the present invention with reference to the accompanying drawings.

### Fist Embodiment

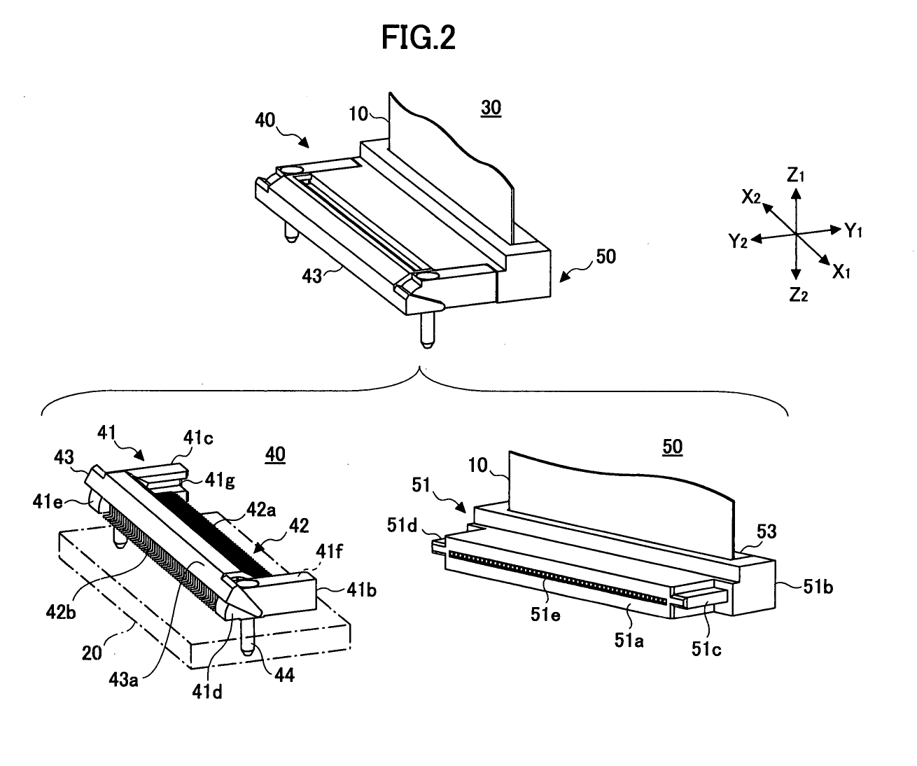

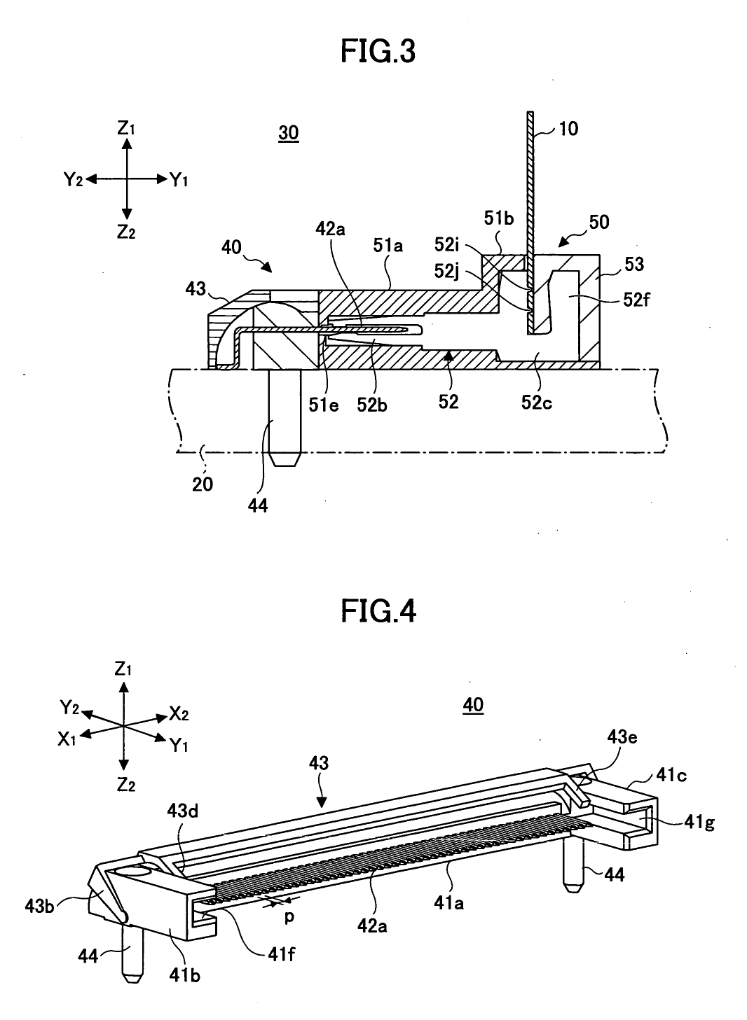

Referring to FIGS. 2 and 3, a connector device 30 according to a first embodiment of the present invention includes a right-angle plug connector 40 mounted on a printed board 20, and a jack connector 50 to which an unterminated end of a flat flexible cable (FFC) 10 is electrically and mechanically connected. The jack connector 50 is configured to be connected to the plug connector 40. When the jack connector 50 is connected to the plug connector 40, wires 11 at an end of the FFC 10 are electrically connected to the printed board 20 through the connector device 30. The FFC 10 is perpendicular to a direction in which the jack connector 50 fits into the plug connector 40. Throughout the drawings, X1-X2 indicates a width direction of the connector device 30; Y1-Y2 indicates a connection direction thereof; and Z1-Z2 indicates a height direction thereof.

[Plug Connector 40]

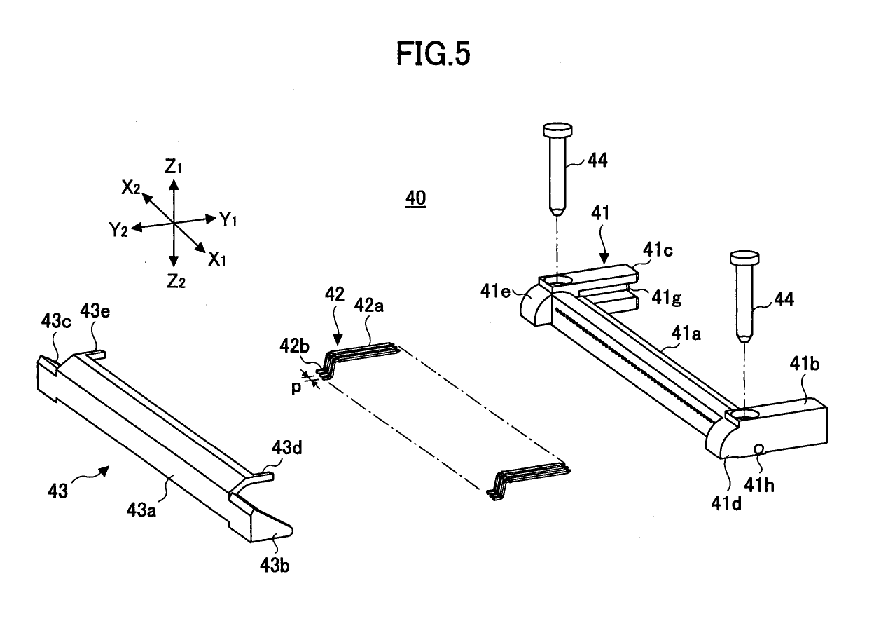

The following describes the plug connector 40 serving as a board-side connector. Referring to FIGS. 4-6B, the plug connector 40 includes an angular C-shaped insulating housing 41, multiple pin type contact members 42 arranged in the X direction in the housing 41, a dust-proof cover 43 attached to the Y2 side of the housing 41, and a pair of positioning pins 44 threaded through the housing 41 in the Z direction and fixed thereto for mounting the plug connector 40 on the printed board 20.

The housing 41 includes a main section 41a elongated in the X direction, arms 41b and 41c extending in the Y1 direction from opposing ends of the main section 41a, respectively, and rear arms 41d and 41e extending in the Y2 direction. Guide grooves 41f and 41g are formed on opposing inner faces of the arms 41b and 41c, respectively.

Each of the contact members 42 includes a pin contact section 42a and a Y2-side crank-shaped terminal section 42b to be soldered. The contact members 42 are inserted through holes of the main section 41a from the Y2 side such that the pin contact sections 42a are arranged between the arms 41b and 41c at intervals p, and that the crank-shaped terminal sections 42b are arranged at the intervals p between the rear arms 41d and 41e.

The dust-proof cover 43 includes a cover main section 43a, arms 43b and 43c extending in the Y1-direction from the Y1 direction from opposing ends of the cover main section 43a, respectively, and projecting pieces 43d and 43e extending in the Y1 direction from vicinities of opposing ends of the cover main section 43a, respectively. The cover main section 43a is configured to cover an area between the rear arms 41d and 41e. The arms 43b and 43c are configured to fit the outer sides of the arms 41b and 41c while shafts (not shown) provided at the front sides of the arms 43b and 43c are fitted in a bearing recess 41h and a bearing recess 41i (not shown) formed in outer faces of the arms 41b and 41c, respectively. Thus, the dust-proof cover 43 is attached to the housing 41 at the Y2 side thereof to be rotatable about the bearing recesses 41h and 41i.

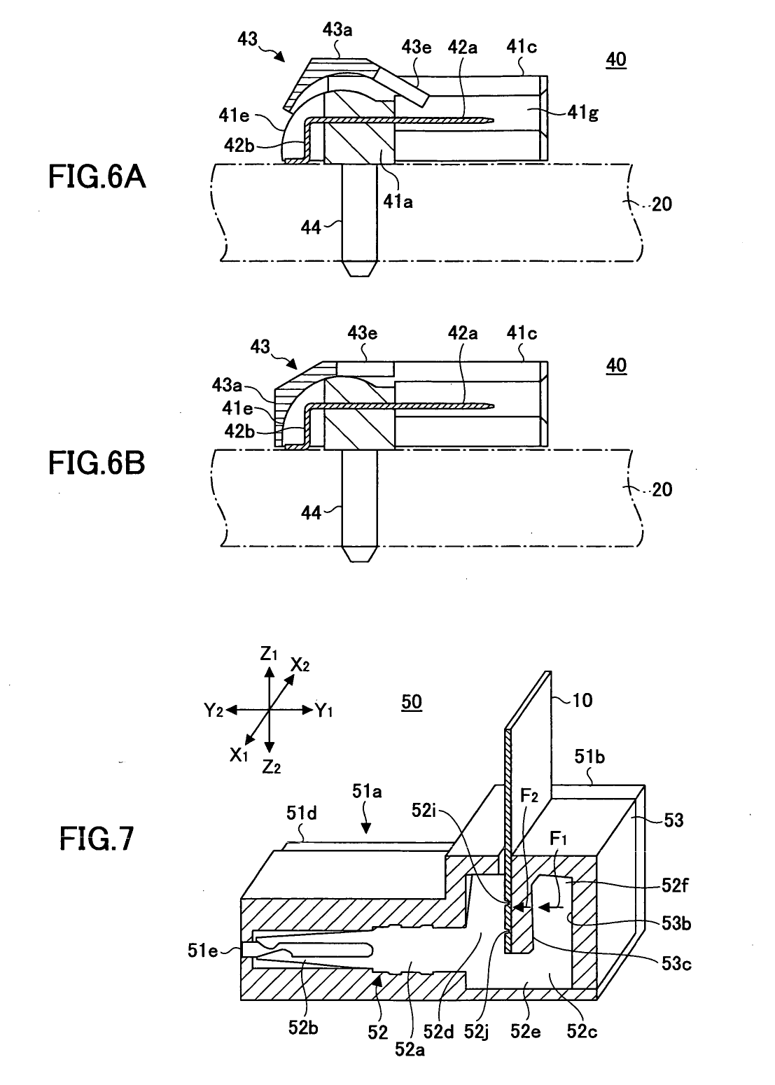

During assembly and shipment of the plug connector 40, the dust-proof cover 43 is rotated in the clockwise direction viewed from the X1 side and locked in the position shown in FIGS. 4 and 6A by an engagement of a recess and a projection (both not shown). In this state, an area where the terminal sections 42b are arranged is not covered, and front ends of the projecting pieces 43d and 43e are located at positions opposing the guide grooves 41f and 41g, respectively. The reason that the area where the terminal sections 42b are arranged is not covered is because to surely heat the terminal sections 42b in a reflow process. The reason that the front ends of the projecting pieces 43d and 43e are located at the positions opposing the guide grooves 41f and 41g is to cause front ends of the projecting pieces 43d and 43e to be pushed by a front end of the jack connector 50 upon connecting the jack connector 50 to the plug connector 40.

When the dust-proof cover 43 is rotated in the counterclockwise direction viewed from the X1 side until it is locked in the position shown in FIGS. 3 and 6B with a clicking sound by an engagement of a recess and a projection (both not shown), the cover main section 43a covers the area where the terminal sections 42b are arranged.

The plug connector 40 is mounted on the printed board 20 by reflow soldering the terminal sections 42b to a pad formed on the printed board 20, while keeping the dust-proof cover 43 opened as shown in FIGS. 4 and 6A. Because the dust-proof cover 43 is opened during the reflow soldering, the terminal sections 42b are effectively heated and therefore the reflow soldering can be efficiently performed.

Upon connecting the jack connector 50 to the plug connector 40, the front end of the jack connector 50 pushes the front ends of the projection pieces 43d and 43e, so that the dust-proof cover 43 is rotated to the position shown in FIGS. 3 and 6B. Thus, the Z1 side and the Y2 side of the terminal sections 42b soldered on the printed board 20 are covered with the dust-proof cover 43. The X1 and X2 sides of a space in the inner side of the dust-proof cover 43 are shut by the rear arms 41d and 41e, respectively. If the terminal sections 42b are exposed during use of an apparatus in which the plug connector 40 is attached, dust floating inside the apparatus is adhered to the terminal sections 42b in some years due to static electricity. The adhered dust may cause troubles such as short circuits between the terminal sections 42b. Covering the terminal sections 42b with the dust-proof cover 43 as described above prevents dust adhesion to the terminal sections 42b, thereby minimizing occurrence of short circuits between the terminal sections 42b. The dust-proof cover 43 is kept closed even after the jack connector 50 is disconnected.

[Configuration of Jack Connector 50]

The following describes the jack connector 50 with reference to FIGS. 2-3 and 7-11

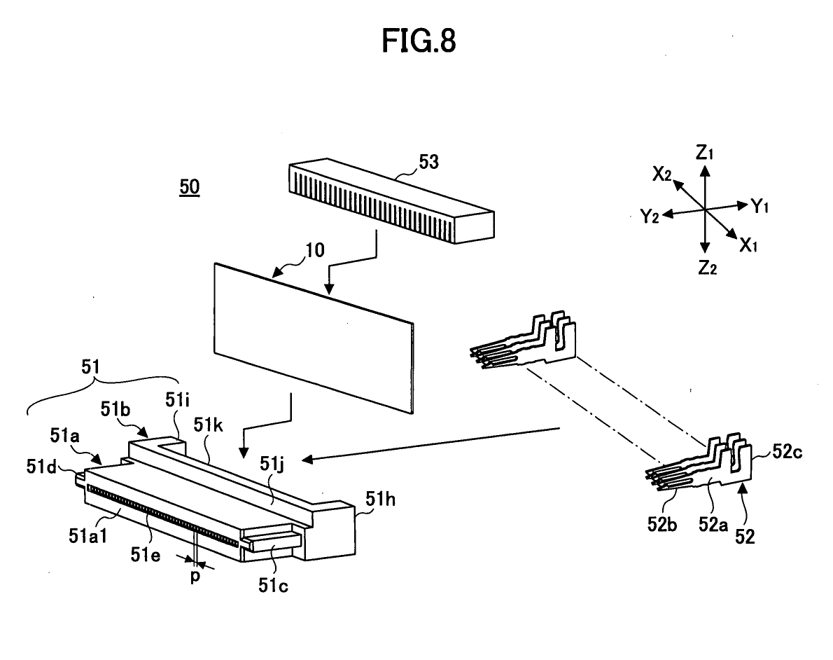

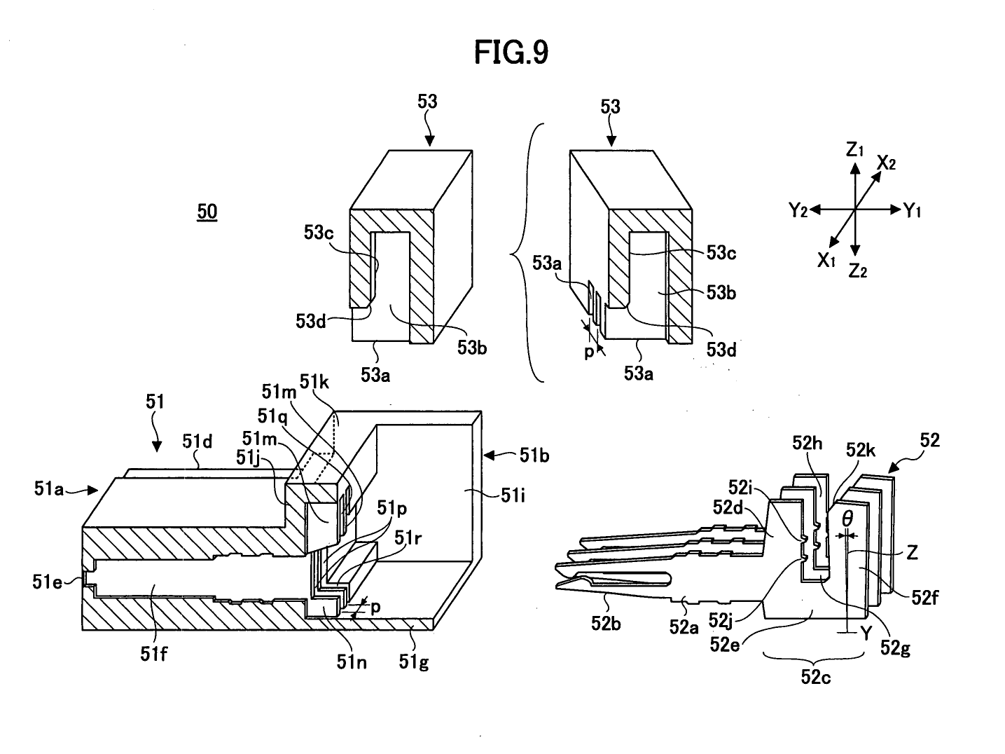

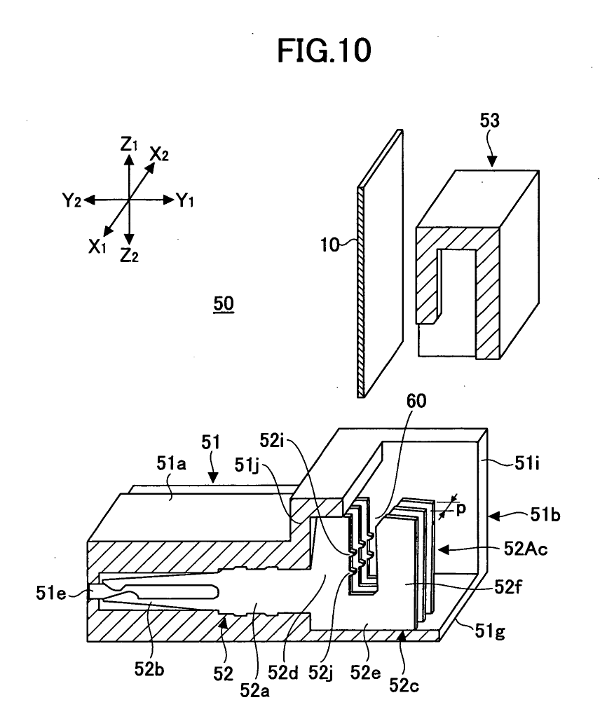

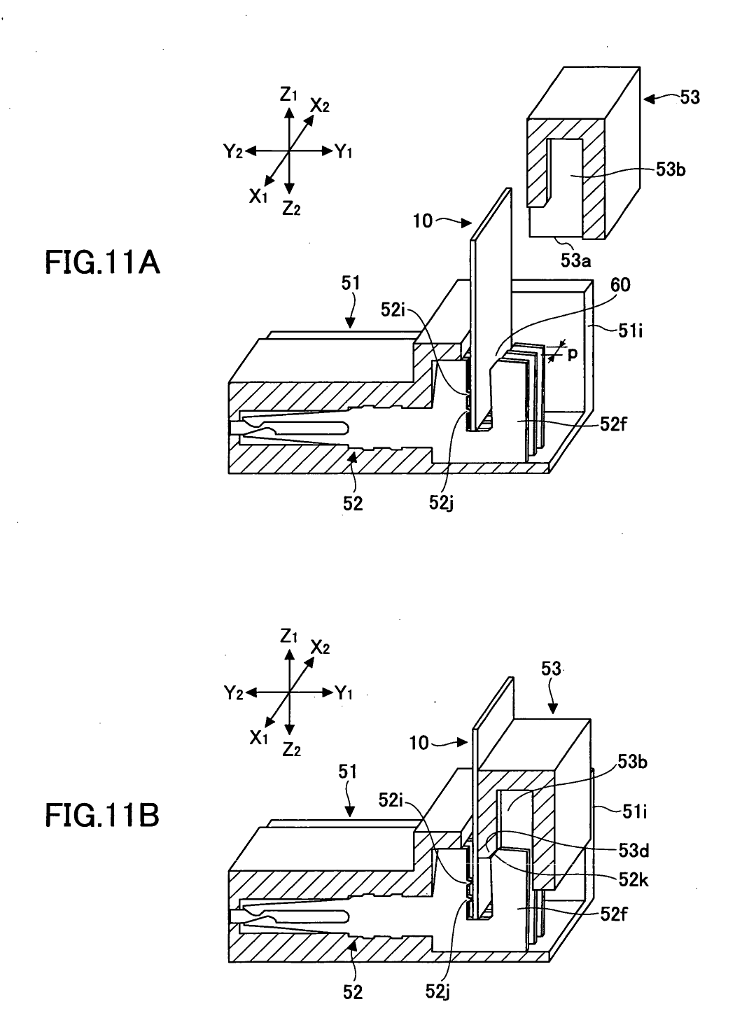

FIG. 7 is a cross-sectional view illustrating the jack connector 50. FIG. 8 shows an exploded view of the jack connector 50 with the FFC 10. FIG. 9 is an exploded cross-sectional view illustrating the jack connector 50. FIG. 10 is an exploded view illustrating the jack connector 50 with contact members 52 mounted therein. FIGS. 11A and 11B are diagrams illustrating operations for connecting the FFC 10 to the jack connector 50.

Referring mainly to FIG. 10, the jack connector 50 includes an insulating housing 51, multiple plate contact members 52 arranged in the X direction and fixed to the housing 51, and a slider 53 configured to fit the housing 51. An unterminated end of the flat flexible cable (FFC) 10 is connected to the jack connector 50 without soldering.

Referring to FIGS. 8 and 9, the housing 51 includes a Y2-side housing section 51a at the Y2 side, and a Y1-side housing section 51b at the Y1 side.

The Y2-side housing section 51a, which is a section fitted into the plug connector 40, includes guide rails 51c and 51d one on each end in the X direction, and multiple openings 51e arranged at the intervals p in the X direction in a front end face 51a1. As shown in FIG. 9, slits 51f communicating with the corresponding openings 51e are arranged in the X direction at the intervals p in the Y2-housing section 51a. The slits 51f are elongated in the Y direction and configured to fit pinch contact sections 52b and center sections 52a of the corresponding contact members. 52.

The Y1-side housing section 51b has a box shape, which is elongated in the X direction and configured to fit FFC connection contact sections 52c of the contact members 52 and the slider 53, with the Z1 and Y1 sides thereof opened, and includes a bottom plate 51g at the Z2 side, end face plates 51h and 51i opposing each other in the X direction, a side plate 51j at the Y2 side, a top plate 51k continuous to the side plate 51j, and partition ribs 51m and 51n. Slit ports 51p corresponding to Y1-side ends of the slits 51f are formed in the side plate 51j. The partition ribs 51m extending across the side plate 51j and the top plate 51k, and the partition ribs 51n extending across the side plate 51j and the bottom plate 51g are formed between adjacent slit ports 51p. Slits 51q are formed between adjacent partition ribs 51m, while slits 51r are formed between adjacent partition ribs 51n.

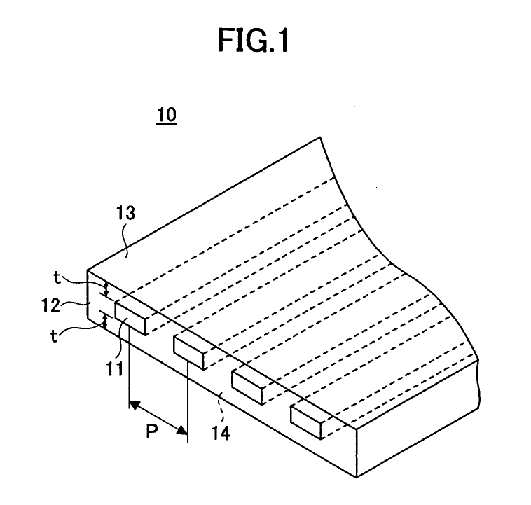

As best shown in FIG. 9, each of the plate contact members 52 includes the center section 52a having a bulging portion, the pinch contact section 52b at the Y2 side, and the FFC connection contact section 52c at the Y1 side. The FFC connection contact section 52c has a U-shape, and includes a base section 52d continuous to the center section 52a and elongated in the Z direction, a bottom arm section 52e extending in the Y1 direction from a Z2-side portion of the base section 52d, and a vertical arm section 52f extending in the Z1 direction from a Y1-side end of the bottom arm section 52e. A clearance 52g is surrounded by the base section 52d, the bottom arm section 52e, and the vertical arm section 52f. The Z1 side of the clearance 52g is an opening 52h. The base section 52d and the vertical arm section 52f are configured to oppose each other. The base section 52d serves as a first arm, while the vertical arm section 52f serves as a second arm. Triangular projections 52i and 52j projecting in the Y1 direction are formed on an edge of the base section 52d at the clearance 52g side. The projections 52i and 52j are configured to pierce the polyester covering 12 to come into contact with the wire 11 of the FFC 10 shown in FIG. 1. An inclined face 52k for facilitating insertion of the slider 53 is formed at the Y2 side of a Z1-side end of the vertical arm section 52f. The vertical arm section 52f is inclined toward the Y2 side at a small angle θ with respect to a Z-axis. The vertical arm section 52f has a width that enables a slight elastic deformation thereof such that an upper end thereof may be moved in the Y1 direction.

Referring to FIG. 10, each of the contact members 52, with the pinch contact section 52b at the Y2 side, is inserted from the Y1 side of the housing 51 into the slit 51f through the slit port 51p. When the center section 52a is pushed into the slit 51f until the base section 52d abuts an inner face of the side plate 51j, the contact member 52 is fixed. The front end of the pinch contact section 52b is arranged to oppose the opening 51e. A Z1-side portion of the base section 52d of the FFC connection contact section 52c is fitted into the slit 51q, while a Z2-side portion of the base section 52d is fitted into the slit 51r. As such, the position of the base section 52d is fixed. The bottom arm section 52e is supported on the bottom plate 51g. The FFC connection contact sections 52c, each arranged as described above, are arranged in the X direction at the intervals p. These FFC connection contact sections 52c arranged in the X direction are referred to as an FFC connection contact section array 52Ac.

As shown in FIG. 10, the FFC connection contact section array 52Ac is exposed except Y2-side portions of the base sections 52d. In the FFC connection contact section array 52Ac, the clearances 52g continuously extend in the X direction, forming a groove 60 opened toward the Z1 side and elongated in the X direction. Inner faces of the end face plates 51h and 51i of the Y1-side housing section 51b define ends of the groove 60 and serve to determine the position of the FFC 10 inserted as described below.

The positions of the base sections 52d are fixed by the partition ribs 51m, 51n and the slits 51q, 51r, so that the base sections 52d are accurately arranged at the intervals p. Also, the base sections 52d are not able to deform in the X direction.

The slider 53 is a rectangular solid with a size that tightly fits into the Y1-side housing section 51b, and includes, as shown in FIG. 9, slit ports 53a each extending across a Z2-side face and a Y2-side face, and slits 53b extending inwardly from the corresponding slit ports 53a. The slit ports 53a and the slits 53b are arranged at intervals p in the X direction. Each of the slits 53b has a shape that fits a part of the bottom arm section 52e and the vertical arm section 52f of the FFC connection contact section 52. The slider 53 further includes a wall face 53c facing the Y2 side of the slit 53b, and an inclined face 53d formed at a Z2-side end of the wall face 53c for facilitating insertion of the slider 53.

[Connecting FFC 10 to Jack Connector 50]

The following describes operations for connecting the FFC 10 to the jack connector 50.

The FFC 10 has an end which is simply cut, or an unterminated end, as shown in FIG. 1.

Referring to FIG. 11A, the end of the FFC 10 is inserted into the groove 60 until the end abuts the bottom of the groove 60. The FFC 10 is oriented upright with respect to the housing 51, and a further movement of the FFC 10 in the Z2 direction is prevented. The opposing side ends of the FFC 10 in the width direction abut inner faces of the end face plates 51h and 51i, respectively, and thus the position of the FFC 10 in the X direction is determined. In this state, the wires 11 oppose the corresponding base sections 52d of the contact members 52.

Then, the slider 53 is pushed and fitted into the Y1-side housing section 51b from the Z1 side.

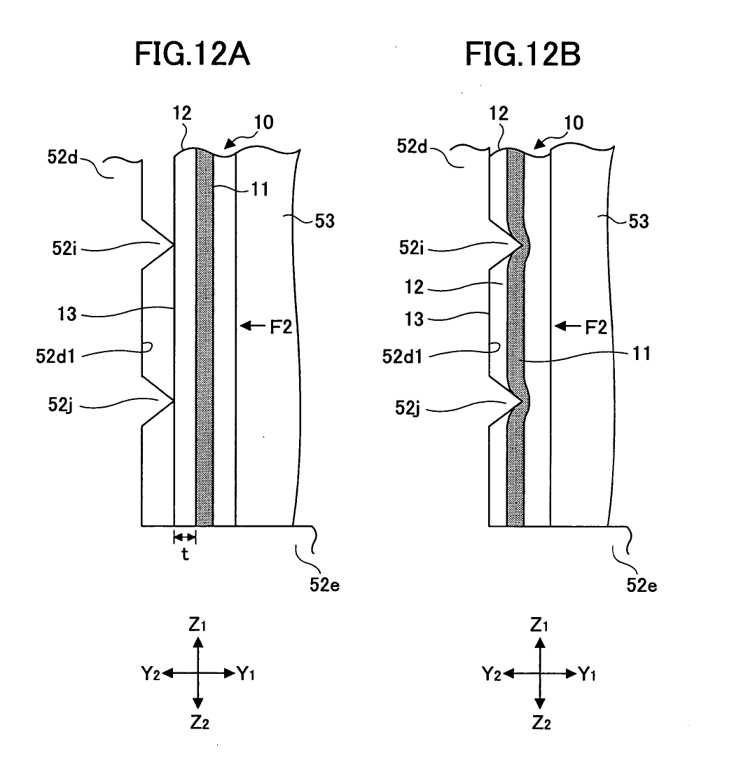

First, opposing ends of the slider 53 abut the end face plates 51h and 51i, respectively, and thus the position of the slider 53 in the X direction is determined. Then, the slit ports 53a are fitted onto a Z1 end of the vertical arm section 52f. Subsequently, with reference to FIG. 11B, the slider 53 is lightly pushed in to move the FFC 10 to the Y2 side in the groove 60. Thus, the inclined face 53d comes into contact with the inclined face 52k of the vertical arm section 52f. Meanwhile, projections 52i and 52j come into contact with the FFC 10 as shown in FIG. 12A.

When the slider 53 is strongly pushed in, the inclined face 53d slides on the inclined face 52k to elastically deform the vertical arm section 52f in the clockwise direction. The wall face 53c holds a Y2-side end face of the vertical arm section 52f to keep the vertical arm section 52f deformed. The slider 53 is pushed and fitted into a final position shown in FIG. 7 where the slider 53 abuts the bottom plate 51g.

While the slider 53 is pushed in, the slider 53 slides on a Y1-side face of the FFC 10 without moving the FFC 10 in the Z2 direction.

The vertical arm section 52f generates an elastic force F1, which is applied to the wall face 53c. Accordingly, a force F2 in the Y2 direction is applied to the slider 53. The FFC 10 is strongly pushed against a Y2-side face of the groove 60 by the slider 53, so that the projections 52i and 52j pierce the polyester covering 12 to come into contact with and press the wire 11 as shown in FIG. 12B. As such, all the wires 11 of the FFC 10 are electrically connected to the corresponding contact members 52 of the jack connector 50.

Because wires 11 are merely pressed against the projections 52i and 52j without being dragged on the projections 52i and 52j, the wires 11 are prevented from damage.

The position of the FFC 10 in the X direction is fixed and the positions of the projections 52i and 52j are determined by the partition ribs 51m, 51n and the slits 51q, 51r. Therefore, even when the interval p is as narrow as, for example, 0.5 mm, the projections 52i and 52j are press-fitted on the approximate center of the corresponding wire 11 to ensure there is an electrical connection.

As the final position of the FFC 10 in the Y direction is where the Y2-side face 13 of the FFC 10 is held on an end face 52d1 of the base section 52d as shown in FIG. 12B, the wire 11 is prevented from being pressed excessively hard against the projections 52i and 52j and thus being locally excessively curved and damaged.

The projections 52i and 52j pierce the polyester covering 12 to partly bite into the wire 11. Accordingly, the FFC 10 is mechanically surely connected to the jack connector 50.

Since the bottom arm section 52e is supported on the bottom plate 51g, the FFC connection contact section 52c is not curved in the Z2 direction even if the slider 53 is strongly pushed in. Therefore, the slider 53 can be smoothly fitted into the Y1-side housing section 51b.

When the FFC 10 is connected to the jack connector 50, all the vertical arm sections 52f and the bottom arm sections 52e are covered by the slider 53, thereby preventing short circuits.

As each of the wires 11 is electrically connected to the corresponding contact member 52 at two points, the reliability of electrical connection is higher compared to a case where the wire 11 is electrically connected at only one point.

The front end of the FFC 10 is stored inside the jack connector 50 without being exposed outside the jack connector 50, thereby preventing short circuits.

A printed wiring cable that has a wiring pattern serving as a conductive line and having a surface coated with polyimide resin may be used in place of the FFC 10, and can be connected to the jack connector 50 in the same manner as described above. In this case, the projections 52i and 52j pierce the polyimide resin to come into contact with the wiring pattern.

[Connecting Jack Connector 50 to Plug Connector 40]

Referring back to FIGS. 2 and 3, the guide rails 51c and 51d of the jack connector 50 are guided by the guide grooves 41f and 41g, and the pin contact sections 42a relatively pass through the openings 51e to be inserted into the corresponding pinch contact sections 52b. In this way, the jack connector 50 is connected to the plug connector 40. As a result, the wires 11 at the end of the FFC 10 are electrically connected to the printed board 20 through the connector device 30. The front ends of the projecting pieces 43d and 43e are pushed by the front end the jack connector 50, so that the dust-proof cover 43 is rotated in the position shown in FIGS. 3 and 6B to cover the terminal sections 42b soldered to the printed board 20.

### Second Embodiment

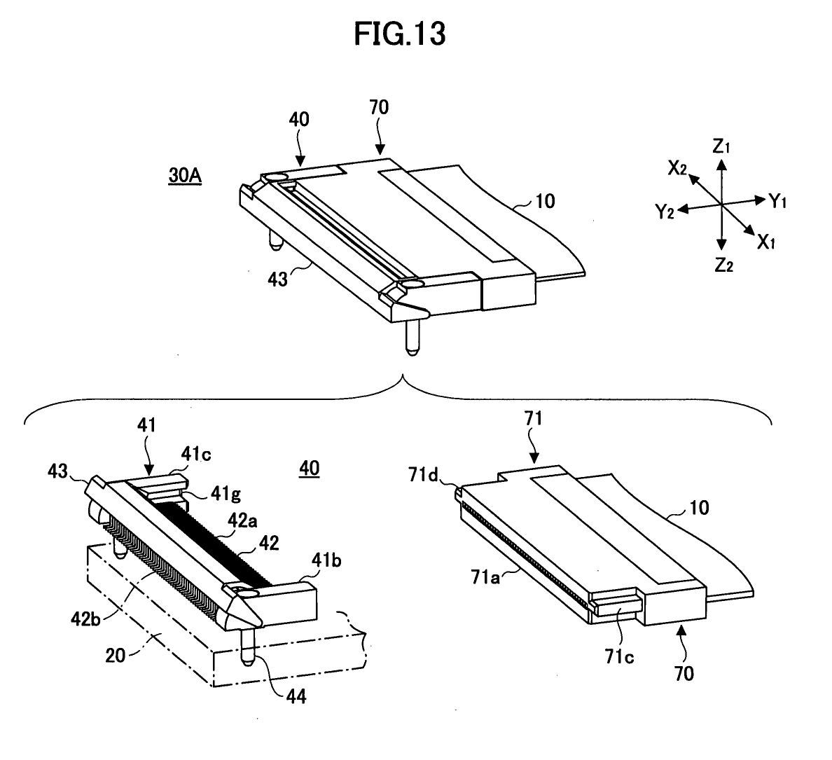

FIG. 13 is a perspective view illustrating a connector device 30A according to a second embodiment of the present invention. The connector device 30A includes a plug connector 40 and a jack connector 70 connected to the plug connector 40. An unterminated end of an FFC 10 is connected to the jack connector 70. Comparing the connector device 30A with the connector device 30 of FIG. 2, the jack connector 70 is different from the jack connector 50 of FIG. 2 in that the orientation of the FFC 10 with respect to the jack connector 70 is the direction in which the jack connector 70 is connected to the plug connector 40.

The following describes the jack connector 70 in detail.

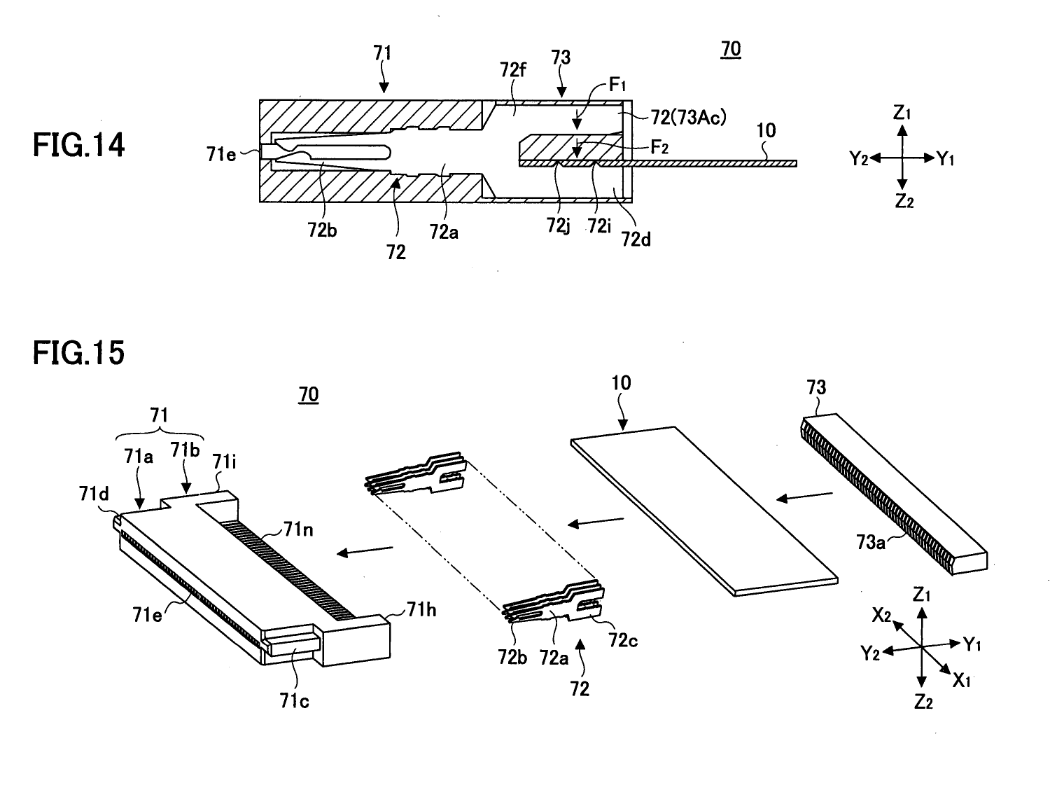

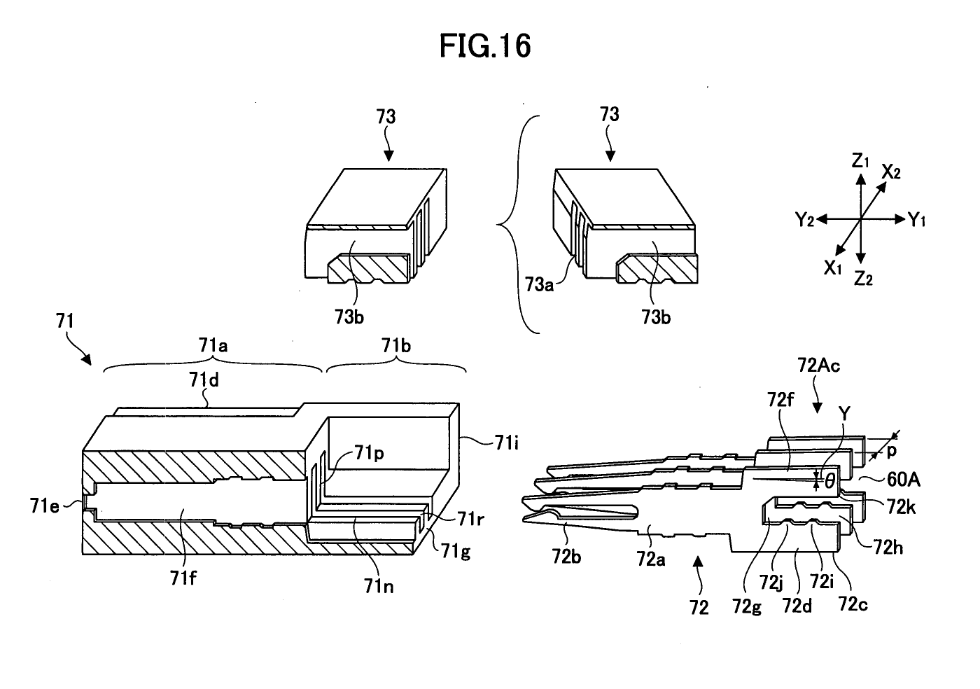

FIG. 14 is a cross-sectional view illustrating the jack connector 70. FIG. 15 is an exploded view illustrating the jack connector 70. FIG. 16 is an exploded cross-sectional view of the jack connector 70.

The jack connector 70 includes an insulating housing 71, multiple plate contact members 72 arranged in the X direction in the housing 71, and an insulating slider 73 configured to fit the housing 71. The unterminated end of the FFC 10 is connected to the jack connector 70 without soldering.

Each of the contact members 72 includes a center section 72a having a bulging portion, a pinch contact section 72b at the Y2 side, and an FFC connection contact section 72c at the Y1 side. The center section 72a and the pinch contact section 72b are identical to the center section 52a and the pinch contact section 52b of FIG. 9. The FFC connection contact section 72c has a U-shape opened toward the Y1-side, and includes a Z1-side horizontal arm section 72f, a Z2-side horizontal arm section 72d, a clearance 72g, an opening 72h, and triangular projections 72i and 72j formed on the Z2-side horizontal arm section 72d. The Z1-side horizontal arm section 72f is inclined toward the Z2 side at a small angle θ with respect to a Y-axis and is elastically slightly deformable in the Z1 direction. The Z2-side horizontal arm section 72d serves as a first arm, while the Z1-side horizontal arm section 72f serves as a second arm.

The housing 71 includes a Y2-side housing section 71a at the Y2 side, and a Y1-side housing section 71b at the Y1 side. The Y2-side housing the housing section 71a, which is identical to the Y2-side housing the housing section 51a, includes guide rails 71c and 71d, slits 71f, and slit ports 71p. The Y1-side housing section 71b has a box shape, which is elongated in the X direction and configured to accommodate the FFC connection contact sections 72c therein, with the Z1 and Y1 sides thereof opened, and includes a bottom plate 71g at the Z2 side, end face plates 71h and 71i opposing each other in the X direction, and partition ribs 71n formed on the bottom plate 71g.

Referring to FIG. 16, the pinch contact sections 72b and the center sections 72a of the contact members 72 are pushed into the corresponding slits 71f. The FFC connection contact sections 72c are arranged in the X direction at the intervals p in the Y1-side housing section 71b. The Z2-side horizontal arm sections 72d of the FFC connection contact sections 72c are fitted into the corresponding slits 71r, while adjacent FFC connection contact sections 72c are separated by the partition ribs 71n. The FFC connection contact sections 72c arranged in the X direction are referred to as an FFC connection contact section array 72Ac. In the FFC connection contact section array 72Ac, a groove 60A opened toward the Y1 side and elongated in the X direction is formed.

With reference to FIGS. 15 and 16, the slider 73 is a rectangular solid with a size that tightly fits into the Y1-side housing section 71b from the Y1 side, and includes slit ports 73a each extending across a Y2-side face and a Z2-side face thereof, and slits 73b extending inwardly in the Y1 direction from the corresponding slit ports 73a.

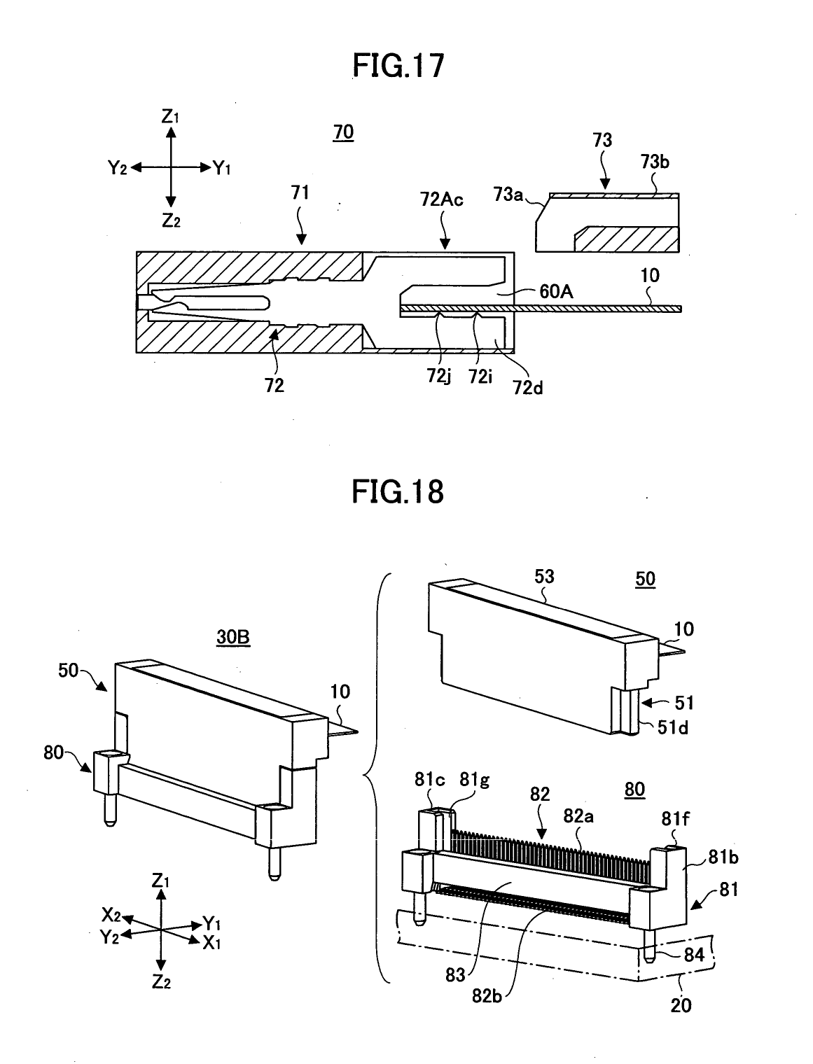

Referring to FIG. 17, the simply cut and unterminated end of the FFC 10 is inserted into the groove 60A from the Y1 side until the end abuts the groove 60A. The slider 73 is strongly pushed into the Y1-side housing section 71b to be fitted into the groove 60A. In this way, the FFC 10 is electrically and mechanically connected to the jack connector 70. More specifically, each of the Z1-side horizontal arm sections 72f is relatively inserted into the corresponding slit 73b and is elastically deformed in the Z1 direction. The slider 73, to which an elastic force F1 (FIG. 14) of the Z1-side horizontal arm section 72f is applied, strongly pushes the FFC 10 against the Z2-side horizontal arm section 72d with a force F2, so that the projections 72i and 72j pierce a polyester covering 12 to come into contact with and press the wire 11 in the same manner as shown in FIG. 12B. As such, the FFC 10 is electrically and mechanically connected to the jack connector 70. The FFC connection contact sections 72c are covered with the slider 73.

Referring to FIG. 13, the guide rails 71c and 71d of the jack connector 70 are guided by the guide grooves 41f and 41g, and the pin contact sections 42a relatively pass through the openings 71e to be inserted into the corresponding pinch contact sections 72b. Thus, the jack connector 70 is connected to the plug connector 40. As a result, the wires 11 at the end of the FFC 10 are electrically connected to the printed board 20 through the connector device 30A.

### Third Embodiment

FIG. 18 shows a connector device 30B according to a third embodiment of the present invention. The connector device 30B includes a straight plug connector 80 mounted on a printed board 20, and a jack connector 50 to which an unterminated end of an FFC 10 is electrically and mechanically connected. The jack connector 50 is configured to be connected to the plug connector 80.

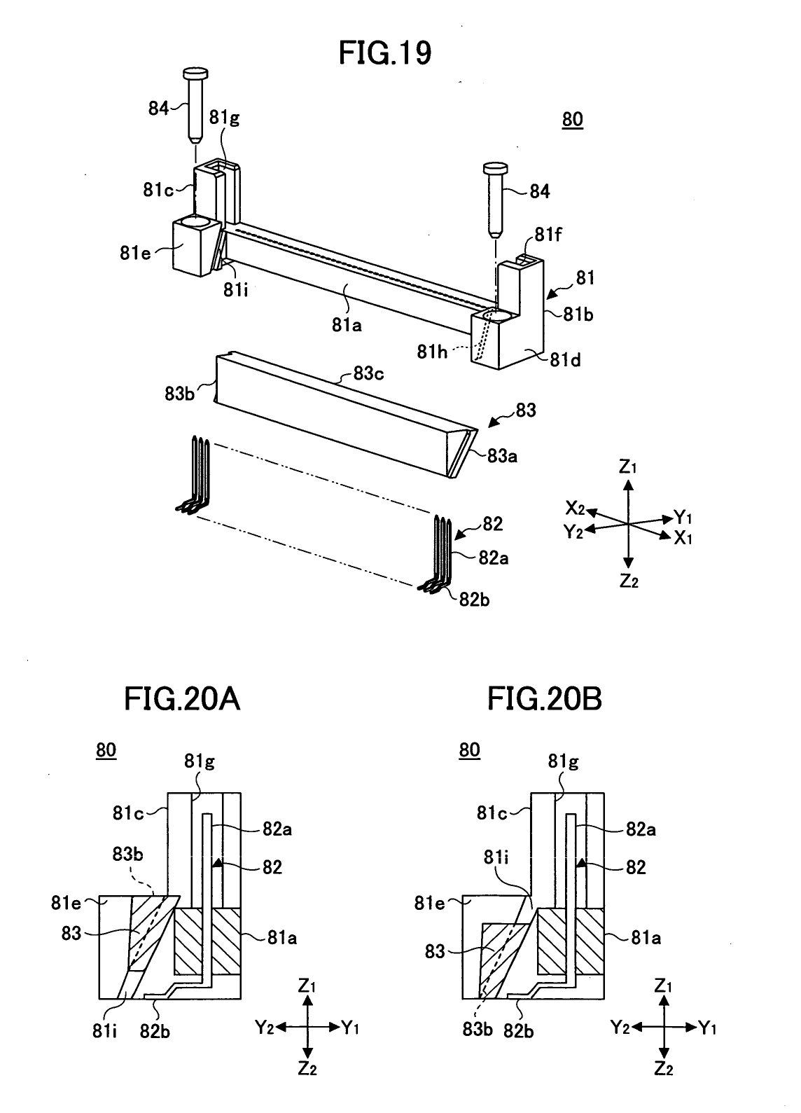

Referring to FIGS. 18 and 19, the plug connector 80 serving as a board-side connector includes a housing 81, multiple pin type contact members 82 inserted in the Z direction through the housing 81 and arranged in the X direction, a dust-proof cover 83 attached to the Y2 side of the housing 81, and a pair of positioning pins 84 threaded through the housing 81 in the Z direction and fixed thereto for mounting the plug connector 80 on the printed board 20.

The housing 81 includes a main section 81a elongated in the X direction, arms 81b and 81c extending in the Z1 direction from opposing ends of the main section 81a, respectively, and horizontal arms 81d and 81e extending in the Y2 direction. Guide grooves 81f and 81g are formed on opposing inner faces of the arms 81b and 81c, respectively. Diagonal guide grooves 81h and 81i for guiding the dust-poof cover 83 are formed on opposing inner faces of the horizontal arm sections 81d and 81e, respectively.

Each of the contact members 82 includes a pin contact section 82a and a Z2-side terminal section 82b folded to the Y2 side. The contact members 82 are inserted through holes of the main section 81a such that the pin contact sections 82a are arranged between the arms 81b and 81c in the X direction to extend toward the Z1 direction, and that the terminal sections 82b are arranged in the X direction between the horizontal arms 81d and 81e to extend toward the Y2 direction.

The dust-proof cover 83 formed in an elongated plate shape includes guide rails 83a and 83b. The guide rails 83a and 83b are configured to slidingly fit into the guide grooves 81h and 81i, respectively, such that the dust-proof cover 82 is attached between the horizontal arms 81d and 81e. During assembly of the plug connector 80, the dust-proof cover 83 is located in an upper position, I.e., an opening position shown in FIG. 20A to keep the terminal sections 82b uncovered.

The plug connector 80 is mounted on the printed board 20 by reflow soldering the terminal sections 82b to a pad formed on the printed board 20, while keeping the dust-proof cover 83 opened. Because the dust-proof cover 83 is opened to expose the terminal sections 82b, reflow soldering can be smoothly performed. A flat upper face 83c of the dust-proof cover 83 serves as a sucking face when a mounting device vacuum sucks the plug connector 80.

With reference to FIG. 18, guide rails 51d of the jack connector 50 are guided by the guide grooves 81f and 81g of the plug connector 80, so that the jack connector 50 is connected to the plug connector 80. The dust-proof cover 83 is pushed and moved diagonally downwardly along the guide grooves 81h and 81i by a front end face of the jack connector 50 to cover the terminal sections 82b as shown in FIG. 20B. When the jack connector 50 is connected to the plug connector 80, wires 11 at the end of the FFC 10 are electrically connected to the printed board 20 through the connector device 30B.

### Fourth Embodiment

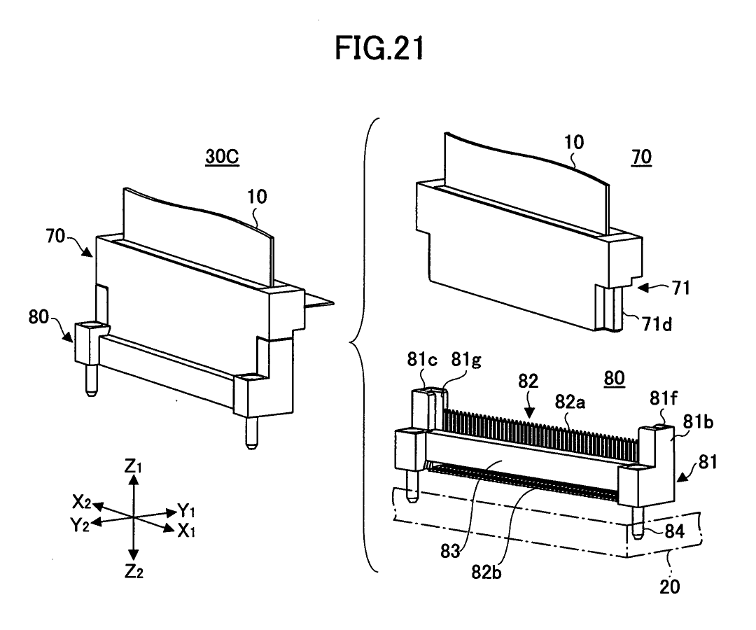

FIG. 21 shows a connector device 30C according to a fourth embodiment of the present invention. The connector device 30C includes a straight plug connector 80 mounted on a printed board 20, and a straight jack connector 70 to which an unterminated end of an FFC 10 is electrically and mechanically connected. Guide rails 71d of the jack connector 70 are guided by guide grooves 81f and 81g of the plug connector 80, so that the jack connector 70 is connected to the plug connector 80. When the jack connector 70 is connected to the plug connector 80, wires 11 at the end of the FFC 10 are electrically connected to the printed board 20 through the connector device 30C.

The present application is based on Japanese Priority Application No. 2004-380580 filed on Dec. 28, 2004, with the Japanese Patent Office, the entire contents of which are hereby incorporated by reference.

1. A connector to which an end of a flat ribbon cable including a conductive line covered with a covering is to be connected, comprising:
a housing;
a contact member secured to the housing, including a flat flexible cable connection contact section that is formed in a U-shape for receiving the end of the flat flexible cable therein and includes a projection on at least one of opposing inner edges of the U-shaped flat flexible cable connection contact section; and
a slider configured to elastically deform the flat ribbon connection contact section;
wherein the flat flexible cable connection contact section and the slider are configured such that when the slider is fitted with respect to the flat flexible connection contact section an elastic force is generated in the flat flexible connection contact section, and the slider presses the flat flexible cable against said at least one of the opposing inner edges of the flat flexible connection contact section such that the projection pierces the covering of the flat flexible cable to come into contact with and press the conductive line.

2. The connector as claimed in claim 1, wherein:
the housing includes a housing section configured to accommodate the flat ribbon cable connection contact section; and
the housing section includes a positioning section adapted to determine a position of the inserted flat ribbon cable in a width direction of the flat ribbon cable.

3. The connector as claimed in claim 1, wherein the flat ribbon cable connection contact section of the contact member includes a plurality of projections, each of said projections having a size corresponding to a thickness of the covering of the flat ribbon cable.

4. The connector as claimed in claim 1, wherein:
the flat ribbon cable connection contact section of the contact member includes a first arm and a second arm opposing each other to form the U-shape;
the second arm is inclined in a direction to narrow an open side of the flat ribbon connection contact section and is configured to be elastically deformed when the slider is fitted with respect to the flat ribbon connection contact section; and
the first arm includes the projection on an edge opposing the second arm.

5. The connector as claimed in claim 4, wherein the slider is configured to cover the second arm of the flat ribbon connection contact section when the slider is fitted with respect to the flat ribbon cable connection contact section.

6. The connector as claimed in claim 1, wherein:
the flat ribbon cable connection contact section of the contact member includes a first arm and a second arm opposing each other to form the U-shape;
the second arm is configured to be elastically deformed when the slider is fitted with respect to the flat ribbon connection contact section;
the first arm includes the projection on an edge opposing the second arm;
the housing includes a housing section accommodating the flat ribbon cable connection contact section, and a partition rib disposed inside the housing section for defining a position of the first arm;
the slider includes a slit into which the second arm is inserted relatively when the slider is fitted with respect to the flat ribbon connection contact section; and
the position of the first arm and the second arm are fixed while the first arm is covered with the housing section and the second arm is accommodated inside the slider.

7. A board-side connector mounted on a board and to which the connector of claim 1 is connected, comprising:
a terminal section connected to the board; and
a dust-proof cover configured to be pushed by the connector when the connector is connected to the board-side connector so as to cover the terminal section connected to the board.
